(19) United States
(12) Patent Application Publication
(10) Pub. No.: US 2005/0018088 A1
(43) Pub. Date: Jan. 27, 2005

(54) Television apparatus provided with fm radio reception

(76) Inventor: Janardhana Bhat, Singapore (SG)

Correspondence Address: Corporate Patent Counsel;Philips Electronics North America Corporation, PO Box 3001, Briarcliff Manor, NY, 10510, US

(21) Appl. No.: 10/497,049

(22) PCT Filed: Nov. 20, 2002
(86) PCT No.: PCT/IB02/04887

(30) Foreign Application Priority Data
Dec. 3, 2001 (SG) PCTSG0100247

(51) Int. Cl. H04N 7/08

(52) U.S. Cl. 348/729; 348/473

(57) ABSTRACT

A television apparatus (100) is switchable to a radio receiver mode. The radio signal is processed in a picture processing path of the television apparatus, transformed to a predetermined auxiliary intermediate radio carrier frequency (f_{IR}) within the picture pass band of the picture processing path, such that the relationship f_{IR}=f_{ref,i}−f_{D} is satisfied, f_{ref,i} being an intrinsic reference frequency of a PLL reference signal generator, and f [symbol] D? being the frequency distance between a predetermined intermediate picture carrier frequency (f_{IP}) and a predetermined intermediate sound carrier frequency (f_{IS}) for television signals.

The present invention relates in general to a television apparatus, adapted to be able to process FM radio signals.

As is commonly known, a television apparatus is designed to receive and process television signals, a television signal or program comprising video signals (picture) and audio signals (sound). Television signals are broadcast by emission of an electromagnetic wave (transmission carrier wave) having a predetermined frequency (RF carrier frequency). Herein, the television signals are modulated on the transmission carrier wave, resulting in a modulated carrier having a certain bandwidth. In order to allow multiple television signals to be broadcast simultaneously, multiple allowed carrier frequencies are defined at mutual distances corresponding to an upper limit of the allowed bandwidth of the modulated carrier; the individual allowed carrier frequencies are referred to as “channel”, numbered consecutively as 1, 2, etc, while the maximum allowed bandwidth of the modulated carrier is indicated as channel width or bandwidth. All channels together occupy a wide range of the electromagnetic spectrum.

A television apparatus is, at least in principle, capable of receiving all television channels, but only the signals of one selected channel are to be processed. To this end, a television apparatus comprises a tuner capable of selecting one channel and providing as output signals the video signal and audio signal of this selected channel, now modulated on respective intermediate carrier frequencies (Picture Intermediate Frequency and Sound Intermediate Frequency, respectively). The exact value of the picture intermediate frequency depends on the television signal format, and is fixed for any specific television apparatus; the same applies for the sound intermediate frequency.

In the television apparatus, the output video signal and output audio signal of the tuner are further processed in order to generate the corresponding picture and sound. The signal paths in such processing will be referred to as video path and audio path, respectively.

Apart from television signals which comprise picture and sound, it is also known to have sound-only signals, indicated as radio signals. Similarly as described above, radio signals are broadcast in radio channels having predetermined carrier frequencies and predetermined channel widths, while radio receivers have a tuner for selecting one of the channels and providing the selected audio signal modulated on an intermediate frequency.

It is desirable to provide a television apparatus which is capable of also handling radio signals. One possibility is to equip a standard television apparatus with additional radio circuitry. In IEEE transactions on Consumer Electronics, Vol.44, No.2, May 1998, p.280, Brekelmans cs describe an example of this approach, where television circuitry and additional radio circuitry are combined in one module. A disadvantage of this approach is that it requires new hardware, which makes this approach rather expensive.

In contrast, it is more cost-efficient to provide a television apparatus where radio signals are handled by the television circuitry. One option is to process the radio signals through the sound path of the television apparatus, but this approach involves some disadvantages, an important disadvantage being that the automatic gain control (AGC) for the tuner section does not function properly any more.

According to an important aspect of the present invention, the radio signals are processed through the picture path of the television apparatus. For correct processing, a phase locked loop (PLL) oscillator in a demodulator section is operated in synthesizer mode with a specifically selected frequency such that the difference between this specifically selected PLL oscillator frequency on the one hand, and a pass band frequency of the picture SAW filter on the other hand, equals the standard second sound intermediate frequency of the television apparatus.

These and other aspects, features and advantages of the present invention will be further explained by the following description of a preferred embodiment of a television apparatus according to the present invention with reference to the drawings, in which same reference numerals indicate same or similar parts, and in which:

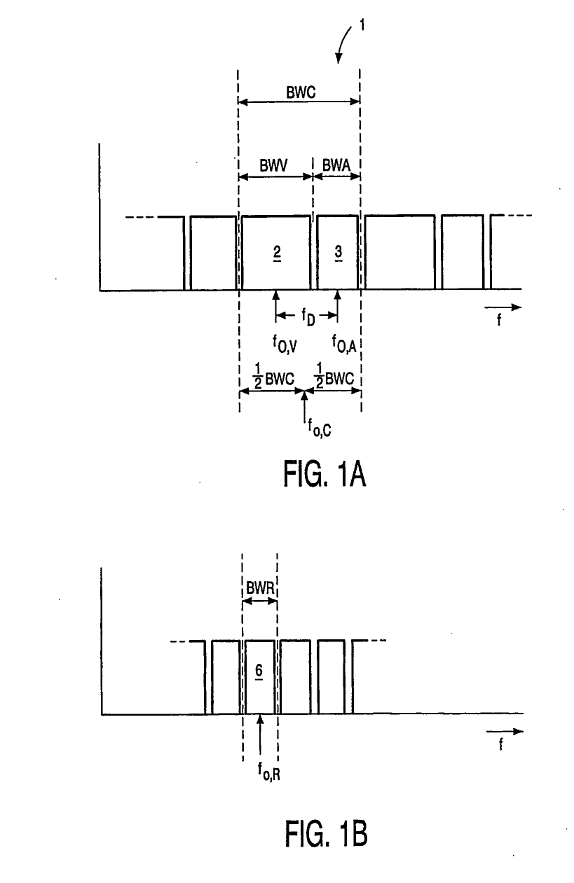

FIG. 1A schematically illustrates the electromagnetic spectrum of television channels;

FIG. 1B schematically illustrates the electromagnetic spectrum of radio channels;

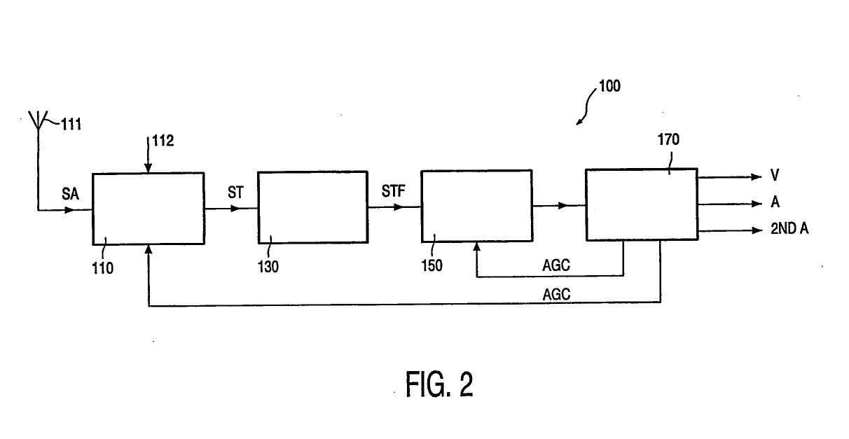

FIG. 2 schematically illustrates the general signal processing in a television receiver;

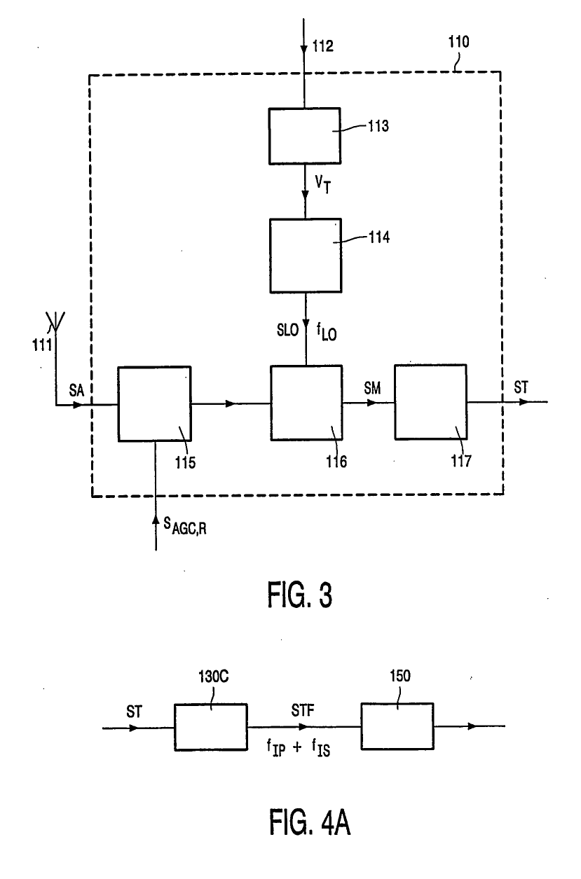

FIG. 3 is a block diagram illustrating the general design and operation of a tuner;

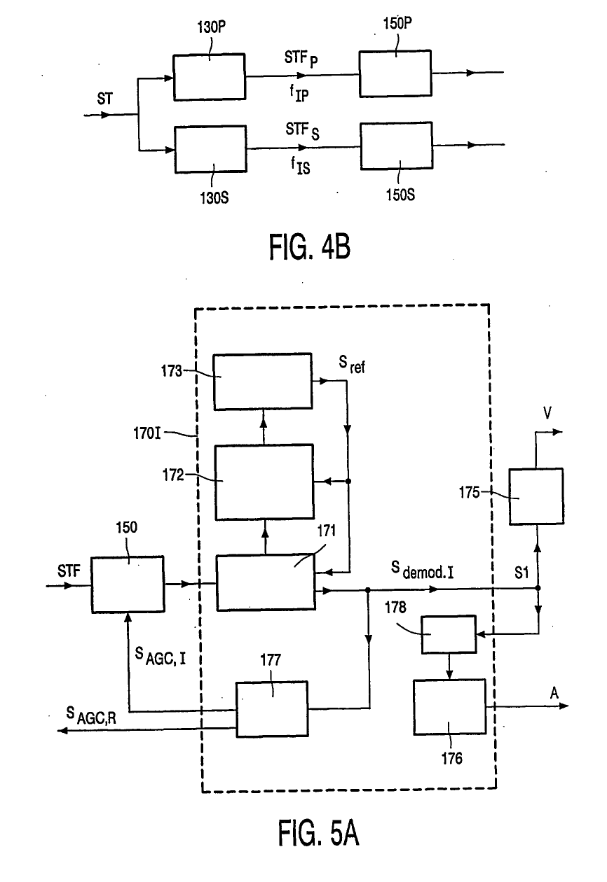

FIG. 4A is a block diagram of a circuit comprising one common channel filter;

FIG. 4B is a block diagram of a circuit comprising a dedicated picture filter and a dedicated sound filter;

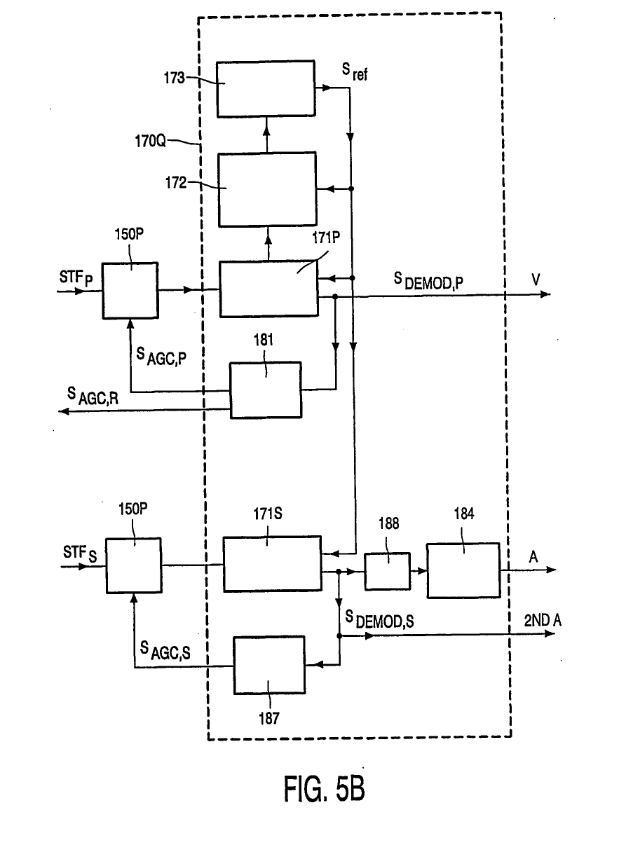

FIGS. 5A and 5B are block diagrams of standard demodulation processors.

FIG. 1A schematically illustrates the electromagnetic spectrum of television channels. A television signal 1 comprises the combination of a video signal 2, having a bandwidth BWV and modulated on a channel video carrier wave with video basic frequency f_{0,V}, and an audio signal 3, having a bandwidth BWA and modulated on a channel audio carrier wave with audio basic frequency f_{0,A}. The frequency distance between video basic frequency f_{0,V} and audio basic frequency f_{0,A} is indicated as f_{D}. The overall bandwidth of the signal 1 is indicated as channel bandwidth BWC. The central frequency of the signal 1 is indicated as channel central frequency f_{0,C}.

The television spectrum comprises a plurality of television channels adjacent each other. Typically, the television spectrum ranges from about 50 MHZ to about 800 MHz, the channels typically having a bandwidth BWC of 6 MHz in the case of the USA system. The channels are numbered consecutively. In a specific example of a second channel, the picture carrier frequency may be 55.25 MHz, the corresponding sound carrier frequency being 60.75 MHz.

Similarly, FIG. 1B schematically illustrates the electromagnetic spectrum of radio channels. A radio signal 6 has a bandwidth BWR and is modulated on a channel radio carrier wave with radio basic frequency f_{0,R}. In this case, the channel central frequency corresponds to the radio basic frequency f_{0,R}, while the channel bandwidth corresponds to the radio bandwidth BWR.

FIG. 2 schematically illustrates the general signal processing in a television receiver 100, for reception of television signals 1 and providing desired video and audio signals corresponding with a selected television channel. Generally, the television receiver 100 comprises a tuner stage 110, a filter stage 130, an amplifier stage 150, and a processor 170.

The tuner stage 110 receives an antenna signal SA from an antenna 111, the antenna signal SA in principle containing all frequencies in the (television) electromagnetic spectrum. On the basis of a command input signal 112, such as issued by a user, the tuner stage 110 generates a tuner output signal ST, which comprises the video and audio signal of one selected television channel, shifted to a predetermined frequency range. The tuner output signal ST is filtered by filter stage 130 to substantially remove all unwanted frequencies outside said predetermined frequency range, and produces a filtered tuner output signal STF which only comprises the desired frequencies of picture and sound signals of the selected channel. The filtered tuner output signal STF, after suitable amplification by amplifier stage 150, is demodulated in processor 170, which provides a video signal V, an audio signal A, and possibly other signals, as will be explained later.

FIG. 3 is a block diagram illustrating the general design and operation of the tuner stage 110.

The wideband antenna signal SA is amplified by a wideband RF amplifier 115.

A local oscillator 114 generates a local oscillator signal SLO with local oscillator frequency f_{LO}, under control of a tuning voltage V_{T} generated by a tuning voltage generator 113 on the basis of said command input signal 112.

A mixer 116 mixes the amplified antenna signal SA and the local oscillator signal SLO such as to produce a mix signal SM. The mixing operation performed by the mixer 116 results in signal components with a certain frequency fᵢ in the amplified antenna signal SA being replaced by corresponding signal components with frequency fᵢ*=f_{LO}−fᵢ in the mix signal SM.

An IF amplifier 117 suitably amplifies the mix signal SM from the mixer 116 to produce the tuner output signal ST.

The filter stage 130 typically comprises surface acoustic wave filters, although other filter designs are possible, as well. Essentially, the filter stage has a filter characteristic passing all frequencies in a first predetermined frequency band around a first predetermined central frequency f1, and also passing all frequencies in a second predetermined frequency band around a second predetermined central frequency f2, and substantially suppressing all other frequencies. The second predetermined central frequency f2 is lower than the first predetermined central frequency f1, according to the formula f1−f2=f_{D}. The total bandwidth of the passband corresponds to the channel bandwidth BWC.

Amplifier 150 suitably amplifies the filter output signal STF. Usually, the frequencies around the second predetermined central frequency f2 are attenuated with respect to the frequencies around the first predetermined central frequency f1, by an amount of 10 dB.

When it is desired to tune to a certain channel, the user inputs a user command 112 indicating the desired channel number or the desired channel frequency. The local oscillator signal SLO is adjusted such that the video basic frequency f_{0,V} of the selected channel is transformed into a frequency component in mix signal SM having a frequency f_{0,V}*=f_{LO}−f_{0,V} coinciding with said first predetermined central frequency f1. It follows that, then, the corresponding audio basic frequency f_{0,A} of the selected channel is transformed into a frequency component in mix signal SM having a frequency f_{0,A}*=f_{LO}−f_{0,A} coinciding with said second predetermined central frequency f2.

Thus, the filter output signal STF always has the same frequency range. The said first predetermined central frequency f1, which always carries the picture signal of the selected channel, will be referred to as intermediate picture frequency f_{IP}, and the said second predetermined central frequency f2, which always carries the sound signal of the selected channel, will be referred to as intermediate sound frequency f_{IS}.

The exact values of the intermediate picture and sound frequencies may in principle be chosen as desired. However, certain systems have been developed, in which those frequencies are specified at specific values. The following Table illustrates a few examples.

| system | region | f_{IP} | f_{IS} | f_{D} | f_{C} |
|---|---|---|---|---|---|
| CCIR | Europe | 38.9 | 33.4 | 5.5 | 36.15 |
| M-std | USA | 45.75 | 41.25 | 4.5 | 43.5 |
| DK | China | 38 | 31.5 | 6.5 | 34.75 |

For instance, in a television apparatus according to the CCIR system, in order to receive the program of channel 3, the local oscillator is tuned to 94.15 MHz: then, antenna signal components having a frequency of 55.25 MHz will be transformed into a mix signal component having a frequency 94.15−55.25=38.9 MHz, which will pass filter 130 as intermediate picture frequency, while antenna signal components having a frequency of 60.75 MHz will be transformed into a mix signal component having a frequency 94.15−60.75=33.4 MHz, which will pass filter 130 as intermediate sound frequency.

Thus, video signals of the selected channel follow a video signal path of intermediate picture carrier defined by intermediate picture frequency f_{IP}, while audio signals of the selected channel follow an audio signal path of intermediate sound carrier defined by intermediate sound frequency f_{IS}. These paths may be spatially separated, or they may be spatially coinciding, as illustrated by FIGS. 4A-B.

FIG. 4A is a block diagram illustrating a design where the tuner output signal ST is supplied to one common channel filter 130C, whose output signal STF comprises intermediate picture frequency f_{IP} as well as intermediate sound frequency f_{IS}.

FIG. 4B is a block diagram illustrating a design where the tuner output signal ST is supplied to a dedicated picture filter 130P, whose output signal STFₚ comprises only intermediate picture frequency f_{IP}, while the tuner output signal ST is also supplied to a dedicated sound filter 130S, whose output signal STF_{S} comprises only intermediate sound frequency f_{IS}. Similarly, the common amplifier 150 is replaced by a dedicated picture amplifier 150P and a dedicated sound amplifier 150S.

It will be clear to a person skilled in the art that the individual bandwidths of the dedicated picture and sound filters 130P and 130S are smaller than the bandwidth of the common channel filter 130C. In the case of the dedicated picture and sound filters 130P and 130S, the filters have different passband central frequencies corresponding to the intermediate picture frequency f_{IP} and the intermediate sound frequency f_{IS}, respectively. In the case of the common channel filter 130C, this filter has a passband central frequency f_{C} in between the intermediate picture frequency f_{IP} and the intermediate sound frequency f_{IS}, as also specified in the above Table.

The design of FIG. 4A is indicated as intercarrier design, whereas the design of FIG. 4B is indicated as Quasi Split Sound (QSS) design.

FIG. 5A is a block diagram schematically illustrating a standard demodulation processor 170I for the intercarrier design, i.e. for use in combination with the filter design illustrated in FIG. 4A. The input signal STF supplied by amplifier 150 is fed to a PLL demodulator 171, which cooperates with a PLL comparator 172 and receives a reference signal S_{ref} from a PLL reference signal oscillator 173. The output signal S_{demod,I} from the PLL demodulator 171 now comprises both the actual video signal (CVBS), freed from the intermediate picture frequency f_{IP}, and also the audio signal, now modulated on a second sound carrier with a central frequency identical to f_{D}. This output signal S_{demod,I} from the PLL demodulator 171 is provided as a first output signal S1 of the demodulation processor 170. For providing the actual video signal V (CVBS), said first output signal S1 is filtered by an external filter 175 which removes the second sound carrier frequency component f_{D}. For providing the actual audio signal A, said first output signal S1 is passed through a bandpass filter 178 having a central frequency corresponding to f_{D} and a bandwidth corresponding to BWA, and processed by an audio demodulator 176, which may be provided as units on board of the same chip as the demodulation processor 170 (as shown), but they may also be external units.

In order to derive control signals for automatic gain control purposes, said output signal S_{demod,I} from the PLL demodulator 171 is also supplied to an internal AGC unit 177 which, at a first AGC output, provides a first AGC control signal S_{AGC,I} for the combined amplifier stage 150 and, at a second AGC output, provides a second AGC control signal S_{AGC,R} for the tuner stage 110.

In this respect, it is to be noted that the first AGC control signal S_{AGC,I} as well as the second AGC control signal S_{AGC,R} for the tuner stage 110 are derived from the video signal.

FIG. 5B is a block diagram similar to FIG. 5A, schematically illustrating a standard demodulation processor 170Q for the QSS design, i.e. for use in combination with the filter design illustrated in FIG. 4B. In contrast to the intercarrier design, where the picture signals and the sound signals are mainly handled by common components, in the QSS design the picture path and the sound path are defined by separate components. The picture input signal STF_{P} supplied by picture amplifier 150P is fed to a PLL picture demodulator 171P, which cooperates with a PLL comparator 172 and receives a reference signal S_{ref} from a PLL reference signal oscillator 173. The output signal S_{demod,P} from the PLL picture demodulator 171P now comprises only the actual video signal, which is provided as a first output signal V of the demodulation processor 170.

The sound input signal STF_{S} supplied by sound amplifier 150S is fed to a PLL sound demodulator 171S, which also receives said reference signal S_{ref} from said PLL reference signal oscillator 173. The output signal S_{demod,S} from the PLL sound demodulator 171S now comprises only the actual audio signal, modulated on said second sound carrier with a central frequency identical to f_{D}, which is provided as a second output signal “2^{ND} A” of the demodulation processor 170. For providing the actual audio signal, said output signal S_{demod,S} from the PLL sound demodulator 171S is filtered by a bandpass filter 188 and demodulated by an FM demodulator 184, whose output signal is provided as a third output signal A of the demodulation processor 170.

Said output signal S_{demod,P} from the PLL picture demodulator 171P is also supplied to a first internal AGC unit 181 which, at a first AGC output, provides a first AGC control signal S_{AGC,P} for the picture amplifier 150P and, at a second AGC output, provides a second AGC control signal S_{AGC,R} for the tuner stage 110. Said output signal S_{demod,S} from the PLL sound demodulator 171S is also supplied to a second internal sound AGC unit 187, whose output signal is provided as a sound AGC control signal S_{AGC,S} for the sound amplifier 150S.

As it is only possible to have one AGC control signal for the tuner 110, while further it is important that the video output signal V of the PLL picture demodulator 171P has a constant amplitude, the AGC control signal for the tuner 110 is provided by said first internal AGC unit 181, i.e. the internal AGC unit of the picture path.

It is noted that, in the standard design, the tuner AGC operates as follows. As long as the antenna signal SA is below a predetermined level, typically 60 dB/μV, the gain of the RF amplifier 115 is constant, namely at the maximum gain of RF amplifier 115. Then, AGC control signals (S_{AGC,I}) [S_{AGC,P}] {S_{AGC,S}} from the AGC circuitries (177) [181] {187} are operative to keep the signal level of the corresponding output signals (V) [V] {A} at a constant level, while the second AGC control signal S_{AGC,R} from AGC circuitries (177) [181] for the tuner stage 110 is kept at a constant level such that the tuner gain stays at its maximum value. Only if the antenna signal SA is above said predetermined level, the gain of the RF amplifier 115 is varied by said second AGC control signal S_{AGC,R} from AGC circuitries (177) [181], such as to keep the signal level of the tuner output signal ST substantially constant at a predetermined level, typically about 105 dB/μV. Then, the AGC control signals (S_{AGC,I}) [S_{AGC,P}] {S_{AGC,S}} from the AGC circuitries (177) [181] {187} are operative to keep the gain of the corresponding amplifiers (150) [150P] {150S} at a substantially constant value.

It is noted that, in the QSS design, the PLL demodulator 171S of the sound path receives the output signal from PLL comparator 172, which interacts with PLL demodulator 171P of the picture path on the one hand and PLL reference signal oscillator 173 on the other hand. The PLL reference signal oscillator 173 generates a PLL reference signal S_{ref} having a frequency f_{ref} close to the intermediate picture frequency f_{IP}. The PLL comparator 172 compares the phase of the PLL reference signal S_{ref} with the phase of the picture carrier signal received at the input of PLL demodulator 171P, and locks the PLL reference signal S_{ref} to this input signal. Therefore, the output signal of the PLL comparator 172 is a signal having the same frequency and phase of the picture carrier signal received at the input of PLL demodulator 171P. This output signal is also received by the PLL demodulator 171S of the sound path, whose output signal, therefore, has the audio information signal modulated on a carrier having a frequency equal to the difference between the frequency of the output signal of the PLL comparator 172 and the intermediate sound frequency f_{IS}, i.e. f_{D}, according to the formula:
f_{171S}=f_{ref}−f_{IS}=f_{ref}−(f_{IP}−f_{D})=f_{D}

In a standard design, the PLL reference signal oscillator 173 can be switched between two operative modes, the intrinsic frequency f_{ref} of the PLL reference signal S_{ref} differing in those two operative modes. For instance, in a particular standard design, the PLL reference signal oscillator 173 can operate in a first operative mode where the intrinsic frequency f_{ref,1} of the PLL reference signal S_{ref} equals 42 MHz, and it can operate in a second operative mode where the intrinsic frequency f_{ref,2} of the PLL reference signal S_{ref} equals 48 MHz. Although the PLL reference signal oscillator 173 basically is switchable, in practice it is set to operate in one fixed mode depending on the system in which it is used. For instance, in a USA system it will be fixed to the second mode (48 MHz), whereas in a Europe system it will be fixed to the first mode (42 MHz). During operation, the actual output signal of the PLL reference signal oscillator 173 will be influenced by the action of the PLL comparator 172, as mentioned, such that the actual output signal S_{ref} has the frequency of the intermediate picture carrier.

In the above, a standard system for processing television signals has been described. Difficulties arise if the standard system is used for processing FM radio signals. Conventionally, for television systems which have the FM radio feature implemented, it has been standard practice to design those systems in such a way that the signal is processed via the sound path thereof, i.e. converted to the intermediate sound frequency f_{IS}.

Now it is to be noted that, in the intercarrier concept of FIG. 5A, the AGC unit 177 functions on the basis of video signals. Further, it is to be noted that, in the filtered tuner output signal STF input to the demodulation processor 170I, the signal level of the intermediate sound frequency f_{IS} is more than 10 dB lower than the signal level of the intermediate picture frequency f_{IP}, which is a standard requirement for normal intercarrier signal processing in order to reduce intermodulation. As the AGC signals from AGC unit 177 are generated on the basis of the overall input signal level of the input signal for the demodulation processor 170, the signal level at the tuner output increases more than 10 dB before the second AGC control signal S_{AGC,R} to the tuner 110 starts to reduce the tuner gain. Typically, this is about 105+10=115 dB/μV. Since FM radio signals only have a bandwidth of about 400 kHz, the tuner output signal ST may contain many IF signals. Thus, very high signal levels at the tuner output can saturate the tuner input circuits and/or the tuner output circuits. Further, due to an additional attenuation of the intermediate sound frequency in the filter 130C, the sensitivity also can drop by 10 dB.

For these and other reasons, there exists a prejudice against the use of the intercarrier concept, such that, in known television systems which have the FM radio feature implemented, the television system is of the QSS design. Then, the AGC unit 187 can generate AGC control signals S_{AGC,S} for the sound amplifier 150S.

However, AGC control signals S_{ARC,R} for the tuner stage 110 are only generated by the AGC unit 181 of the picture path. In the absence of accompanying picture signals as well as sound signals, the AGC unit 181 can not generate any AGC control signals S_{AGC,R} for the tuner stage 110. In that case, the gain of the tuner stage 110 is always kept at a maximum. Then, if the signal level at the tuner input is relatively high, the sound amplifier 150S may get saturated, as well as the tuner input circuits and the tuner output circuits.

In this respect it is to be noted that the radio channels are closer spaced (typically 400 kHz) than television channels, while the tuner stage 110 should be designed to accommodate television channels having a typical bandwidth of 6 MHz, so the tuner stage 110 will pass relatively many neighboring radio channels which, if high level channels, will contribute to the saturation of the sound amplifier 150S. The dedicated sound filter 130S is a narrow band filter having a bandwidth of about 500 kHz. Thus, the AGC control signal S_{AGC,S} for the sound amplifier 150S is generated with respect to the tuned channel signal level only. In the case of an FM radio signal at the antenna input, with many radio signals in the frequency band and possibly high variation in signal levels, the tuner can saturate if the receiver is tuned to a channel with a relatively low signal level. Therefore, for an FM radio reception front-end, normally a wideband AGC concept is preferred, i.e. AGC operation on the basis of the levels of both selected and neighboring channels.

On the other hand, it is to be noted that, in the intercarrier design, the common channel filter 130C shows a very high attenuation for signals with frequencies more than 200 kHz lower than the intermediate sound frequency f_{IS}, but shows very little attenuation for signals with frequencies below (f_{IS}+f_{D}). Thus, neighboring channels with frequencies higher than the selected radio channel (f_{0,R}) have little or no influence on the wideband AGC operation in the case of sound signals following the picture path. So, there is no symmetrical wideband AGC generation.

Further, in known television systems which have the FM radio feature implemented, the tuner 110 is tuned such that the selected radio channel passes channel filter stage 130 via the sound path thereof, i.e. converted to the intermediate sound frequency f_{IS}. However, as described above, such signals do not correspond to an accompanying picture signal, so the PLL comparator 172 is not able to lock the PLL reference signal S_{ref} of the PLL reference signal oscillator 173 to any accompanying intermediate picture frequency f_{IP}. Hence, the PLL reference signal S_{ref} of the PLL reference signal oscillator 173 now only has its intrinsic frequency (free running oscillator).

In the above example of a USA system, where f_{IS}=41.25 MHz and the PLL reference signal oscillator 173 is operated in its second operative mode where the intrinsic frequency f_{ref,2} of the PLL reference signal S_{ref} equals 48 MHz, the output signal S_{demod,S} of the PLL demodulator 171S has a carrier frequency of 6.75 MHz, which does not correspond to the standard value of 4.5 MHz. Similarly, in the above example of a Europe system, where f_{IS}=33.4 MHz and the PLL reference signal oscillator 173 is operated in its first operative mode where the intrinsic frequency f_{ref,1} of the PLL reference signal S_{ref} equals 42 MHz, the output signal S_{demod,S} of the PLL demodulator 171S has a carrier frequency of 8.6 MHz, which does not correspond to the standard value of 5.5 MHz. Then, in order to provide the actual audio signal, some further processing is needed with non-standard components.

One way of dealing with this problem is to use a PLL reference signal oscillator 173 which can be operated in a third mode (radio mode; to be used when processing FM radio channels) where its intrinsic frequency f_{ref,3} would correspond to the standard value of f_{D}. For instance, for the USA situation, such third intrinsic frequency f_{ref,3} would need to be equal to 45.75 MHz, whereas for the Europe situation, such third intrinsic frequency f_{ref,3} would need to be equal to 38.9 MHz. However, in the above example, this requires new development of new PLL reference signal oscillators.

Another way of dealing with this problem is to use a third radio processing path for radio signals, having a dedicated intermediate radio carrier frequency, similar as in an “ordinary” radio receiver. However, this requires additional components.

In order to overcome the above disadvantages, the present invention takes a different approach.

According to a first important aspect of the present invention, the radio signals are processed through the picture path of the television apparatus.

According to a second important aspect of the present invention, the intermediate sound frequency f_{IS} of the intermediate sound carrier is switchable from television mode to radio mode, in which case the intermediate sound frequency f_{IS} is chosen to meet the following criteria:

a) the intermediate sound frequency f_{IS} satisfies the following formula:
f_{IS}=f_{ref,i}−f_{D}
wherein f_{ref,i} is any of the intrinsic frequencies of the PLL reference signal oscillator 173, and wherein f_{D} is the standard second sound carrier frequency as defined above.

b) the intermediate sound frequency f_{IS} is within the passband of common channel filter 130C (intercarrier design) or within the passband of dedicated picture filter 130P (QSS design).

In the above example of a USA system, where f_{D}=4.5 MHz, if the PLL reference signal oscillator 173 is operated in its second operative mode where the intrinsic frequency f_{ref,2} of the PLL reference signal S_{ref} equals 48 MHz, the intermediate sound frequency f_{IS} is chosen to be 43.5 MHz. Similarly, in the above example of a Europe system, where f_{D}=5.5 MHz, if the PLL reference signal oscillator 173 is operated in its second operative mode where the intrinsic frequency f_{ref,2} of the PLL reference signal S_{ref} equals 48 MHz, the intermediate sound frequency f_{IS} is chosen to be 42.5 MHz.

Note that it is to be avoided that the PLL reference signal locks to the intermediate sound frequency f_{IS}. Therefore, the PLL reference signal oscillator 173 should preferably be operated in its synthesizer (fixed) mode. Alternatively, the PLL comparator 172 may be inhibited.

Further, note that the choice of the intrinsic frequency f_{ref,i} of the PLL reference signal oscillator 173 should be such that the intermediate sound frequency f_{IS} is within the pass band of the tuner IF amplifier 117, which typically ranges from 39 MHz to 47 MHz. This requirement is usually already satisfied when the intermediate sound frequency f_{IS} is within the picture pass band of the picture processing path, which typically ranges from 42 MHZ to 45.75 MHz.

Some important advantages are achieved: AGC control of the tuner stage 110 is now possible because the AGC unit 177 receives an input signal within the expected picture carrier frequency range. Further the demodulated output signal S_{demod,I} of the PLL demodulator 171 constitutes a first output signal S1 having the audio signal at the standard second intermediate sound frequency f_{D}, such that further processing can be done with standard components (such as 176).

Further, AGC control can be wideband, which is very much desirable for radio processing. As mentioned above, considering the standard intermediate sound frequency and assuming this is used in the picture processing path, in the intercarrier design any wideband AGC is not symmetrical with respect to adjacent channel levels; in contrast, in the proposal of the present invention, wideband AGC can be symmetrical because the filter 130C or 130P has a substantially flat response in a range around the proposed frequency (in the example mentioned, typically from 41.75 to 45.25 MHz). Further, considering the standard intermediate sound frequency and assuming this is used in the picture processing path, in the QSS design there is no signal on this frequency since the dedicated picture filter 130P attenuates this frequency by more than 35 dB.

Further, since the intermediate carrier signal now used for transferring the sound signal has a frequency closer to the standard intermediate picture frequency, attenuation of the sound signal by the channel amplifier 150 is reduced and performance is improved, comparable to performance in the QSS design.

Further, an important aspect of the present invention is that all of the above advantages are attainable without any hardware change being necessary. Operating the PLL reference signal generator 173 in free running or synthesizer mode can be performed in software. Likewise, adapting the local oscillator 114 such that, in response to a radio channel selection, the local oscillator frequency f_{LO} is set such that the above-mentioned formula is satisfied can be performed in software.

It should be clear to a person skilled in the art that the present invention is not limited to the exemplary embodiments discussed above, but that various variations and modifications are possible within the protective scope of the invention as defined in the appending claims.

1. Method for processing a radio signal in a television apparatus comprising a picture processing path and a sound processing path, wherein the radio signal is processed in the picture processing path.

2. Method according to claim 1, in a television apparatus comprising a demodulation processor (170) with a PLL reference signal generator (173) generating a PLL reference signal with a predetermined intrinsic frequency f_{ref,i}; the method comprising the steps of:
receiving a command input signal (112) indicating a selected radio channel with a selected channel central frequency f_{0,R}; and
transforming the selected radio signal to an auxiliary intermediate carrier having an auxiliary intermediate frequency f_{IR} satisfying the relationship f_{IR}=f_{ref,i}−f_{D}, f_{D} being the frequency distance between associated picture carrier frequency and sound carrier frequency of one television channel.

3. Method according to claim 2, in a television apparatus comprising a tuner (110) with a local oscillator (114) which generates a local oscillator signal (SLO) with local oscillator frequency f_{LO}, and a mixer (116) which mixes an amplified antenna signal (SA) and the local oscillator signal (SLO) such as to produce a mix signal (SM), wherein the mixing operation performed by the mixer (116) results in signal components with a certain frequency fᵢ in the amplified antenna signal (SA) being replaced by corresponding signal components with frequency fᵢ*=f_{LO}−fᵢ in the mix signal (SM);
the method comprising the step of setting the local oscillator frequency f_{LO} to a value satisfying f_{LO}=f_{ref,i}−f_{D}+f_{0,R}

4. Method according to claim 2, in a television apparatus comprising a filter (130; 130P) filtering the tuner output signal (ST), the filter (130; 130P) having a picture signal passband around a predetermined intermediate picture carrier frequency f_{IP};
wherein predetermined intrinsic frequency f_{ref,i} is selected such that auxiliary intermediate frequency f_{IR} is within said passband of said filter (130; 130P).

5. Television apparatus (100), for use in a system where television channels having a bandwidth (BWC) comprise a picture carrier frequency (f_{0,V}) and associated sound carrier frequency (f_{0,A}) at a mutual frequency distance (f_{D}), the television apparatus comprising:
tuner means (110) designed for receiving an antenna signal (SA) and providing a tuner output signal (ST) which comprises the video signal of a tuned television channel transformed to a predetermined intermediate picture carrier frequency (f_{IP}), and which comprises the audio signal of a tuned television channel transformed to a predetermined intermediate sound carrier frequency (f_{IS}=f_{IP}−f_{D});
filter means (130C; 130P) receiving the tuner output signal (ST) and providing a filtered tuner output signal (STF; STF_{P}), the filter (130; 130P) having at least a picture signal passband around said predetermined intermediate picture carrier frequency f_{IP} and having at least a bandwidth corresponding to the video bandwidth (BWV) of the television channel;
amplifier means (150; 150P) suitably amplifying the filtered tuner output signal (STF; STF_{P});
PLL demodulation processor means (170I; 170P) operable in a PLL locking operative state, comprising:
PLL reference signal oscillator means (173) having a control input and a
signal output, adapted to generate at its signal output a reference signal (S_{ref})
of a predetermined intrinsic frequency (f_{ref,i}), responsive to a control signal
received at its control input to adapt the phase of the reference signal;
PLL demodulator means (171; 171P) coupled to receive the filtered tuner
output signal (STF; STF_{P}) as amplified by said amplifier (150; 150P), and to
receive the reference signal (S_{ref}) from the PLL reference signal oscillator
(173), and adapted to generate a demodulated output signal (S_{demod,i}; S_{demod,P});
PLL comparator means (172) coupled to receive the filtered tuner output
signal (STF; STF_{P}) as amplified by said amplifier (150), and to receive the
reference signal (S_{ref}) from the PLL reference signal oscillator (173);
said PLL comparator (172) having a control output coupled to said control
input of said PLL reference signal oscillator (173); said PLL comparator (172)
in a television mode being adapted to generate at its control output a control
signal such that the reference signal (S_{ref}) is locked to the phase and frequency
of the intermediate picture carrier frequency (f_{IP}) in the filtered tuner output
signal (STF; STF_{P});
characterized in that said television apparatus (100) is switchable to a radio receiver mode in which:
said PLL demodulation processor (170I; 170Q) is operable in a synthesizer mode in which the reference signal (S_{ref}) of the PLL reference signal oscillator (173) has its said predetermined intrinsic frequency (f_{ref,i});
said tuner (110) is operable to provide said tuner output signal (ST) such that a frequency band (6) of a selected radio channel with a selected channel central frequency (f_{0,R}) is transformed to a predetermined auxiliary intermediate radio carrier frequency (f_{IR});
wherein the relationship f_{IR}=f_{ref,i}−f_{D} is satisfied;
and wherein the intermediate radio carrier frequency (f_{IR}=f_{ref,i}−f_{D}) is within the picture pass band of the picture processing path.

6. Television apparatus according to claim 5, wherein, in the radio receiver mode, the PLL reference signal oscillator (173) is switchable to a synthesizer mode in which the PLL reference signal oscillator (173) is adapted to ignore any control signal from the comparator (172).

7. Television apparatus according to claim 5, wherein, in the radio receiver mode, the comparator (172) is switchable to a non-comparing mode in which the comparator (172) is adapted to ignore the filtered tuner output signal (STF).

8. Television apparatus according to claim 5, wherein, in the radio receiver mode, the comparator (172) is switchable to a non-generating mode in which the comparator (172) is adapted to inhibit the generation of any control signal for the PLL reference signal oscillator (173).

9. Television apparatus according to claim 5, wherein the PLL reference signal oscillator (173) is adapted to be operated in a plurality of possible reference signal generation modes each characterized by mutually different intrinsic frequencies (f_{ref,i});
and wherein, in the radio receiver mode, the intrinsic frequency (f_{ref,i}) of the PLL reference signal oscillator (173) is selected such that the intermediate radio carrier frequency (f_{IR}=f_{ref,i}−f_{D}) is within the picture pass band of the picture processing path.

10. Television apparatus according to claim 9, wherein in the radio receiver mode, the intrinsic frequency (f_{ref,i}) of the PLL reference signal oscillator (173) is selected such that the intermediate radio carrier frequency (f_{IR}=f_{ref,i}−f_{D}) is within the picture pass band of the filter means (130C; 130P).

11. Television apparatus according to claim 9, wherein said passband is defined as a that part of the frequency characteristic showing an attenuation less than 3 dB.

12. Television apparatus according to claim 5, wherein said tuner means (110) comprise:
a command input for receiving a command input signal (112) indicating a selected radio channel with a selected channel central frequency f_{0,R};
local oscillator means (114) generating a local oscillator signal (SLO) with local oscillator frequency f_{LO}; and
mixing means (116) mixing an amplified antenna signal (SA) and the local oscillator signal (SLO) such as to produce a mix signal (SM), wherein the mixing operation performed by the mixer (116) results in signal components with a certain frequency fᵢ in the amplified antenna signal (SA) being replaced by corresponding signal components with frequency fᵢ*=f_{LO}−fᵢ in the mix signal (SM);
wherein said tuner means (110) are switchable from television receiver mode to radio receiver mode; and wherein said local oscillator means (114) are adapted to generate, in said radio receiver mode, the local oscillator frequency f_{LO} in accordance with the formula
f_{LO}=f_{ref,i}−f_{D}+f_{0,R}

13. Television apparatus according to claim 5, wherein the television apparatus is of the intercarrier design, i.e. picture signals and sound signals are processed by common components.

14. Television apparatus according to claim 5, further comprising AGC control signal generating means (177; 181) for generating wideband AGC signals.
